(19) United States
(12) Patent Application Publication
(10) Pub. No.: US 2011/0120197 A1
(43) Pub. Date: May 26, 2011

(54) Ski pole locking system

(76) Inventors: Matthew G. Molesan, Delran, NJ (US); John P. Fish, Hainesport, NJ (US)

(21) Appl. No.: 12/592,351

(22) Filed: Nov. 24, 2009

(51) Int. Cl. E05B 73/00

(52) U.S. Cl. 70/58

(57) ABSTRACT

A ski pole locking system utilizes a single, unitary body bracket element with one or more U-shaped lateral sections. Each lateral section forms a through passage for the acceptance and maintenance of ski poles. Strategically placed apertures through the bracket element are provided for a locking line which is ultimately secured to a locking device. Ski poles locked within the bracket element present a bulky package which is a deterrent to a would-be thief. The system can also be used to secure and lock skis and other ski equipment, along with the poles.

### BACKGROUND OF THE INVENTION

Skiing continues to gain in popularity as a recreational activity. However, with this increase in popularity, ski equipment has become more specialized, functional and lightweight and thus more expensive. As a result, there has been a corresponding increase in the theft of ski equipment. Ski poles, in particular, are especially vulnerable.

Generally thefts occur when skis and poles are temporarily placed at rest or refreshment areas adjacent to ski slopes or when they are positioned within automobile transport racks. Skis, being the more valuable equipment, are often locked and, in any event, their weight and awkward shape make them more difficult for a thief to take without being noticed. Ski poles, however, also expensive, are less apt to be locked up after being deposited, for example in a ski rack adjacent to a long line of other ski equipment. The lightweight, easily portable nature of ski poles presents an appealing target for the dishonest skier, who will readily exchange a less valuable pair of ski poles for more valuable poles, and then ski or walk away with them. Such stolen poles are virtually impossible to recover, especially when a large number of skiers and visitors frequent the slopes.

While there have been various attempts to provide ski pole locking devices, none have been developed which provide the simplicity of design, economy of manufacture and, especially, ease of use which will prompt the skier to utilize the device to temporarily secure his or her poles.

### SUMMARY OF THE INVENTION

It is thus the object of the present invention to provide a ski pole locking system which overcomes the limitations and disadvantages of prior locking devices and systems.

It is an object of the present invention to provide a ski pole locking system which will permit ski poles, and their associated skis, to be secured to each other, to a post, rail, tree, or like structure, in a manner which results in a bulky package, and thus a deterrence to a would-be thief.

It is another object of the present invention to provide a ski pole locking system which comprises a single, lightweight bracket element which is readily and easily placed around ski poles.

It is a further object of the present invention to provide a ski pole locking system which uses a single, one piece bracket element which is economical to manufacture.

It is another object of the present invention to provide a ski pole locking system which comprises a bracket element which is easily transportable for the quick locking of ski poles and, if desired, skis and other equipment.

These and other objectives are accomplished by the present invention, a ski pole locking system which utilizes a single, unitary body bracket element with one or more U-shaped lateral sections. Each lateral section forms a through passage for the acceptance and maintenance of ski poles. Strategically placed apertures through the bracket element are provided for a locking line which is ultimately secured to a locking device. Ski poles locked within the bracket element present a bulky package which is a deterrent to a would-be thief. The system can also be used to secure and lock skis and other ski equipment, along with the poles.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the ski pole locking system of the present invention in use to secure and lock ski poles and skis.

FIG. 2 is an isometric view of the bracket element and locking line of the ski pole locking system of the present invention.

FIG. 3 is a top view of the bracket element and locking line of the ski pole locking system of the present invention.

FIG. 4 is a top view of an alternate embodiment of the bracket element and locking line of the ski pole locking system of the present invention.

### DETAILED DESCRIPTION OF THE INVENTION

The ski pole locking system of the present invention comprises bracket element 2, locking line 4 and locking device 6. Bracket element 2 is a single, solid, unitary body comprising rear section 10, which extends the full length of the bracket element, front section 12 with first arm member 14 and second arm member 16, each extending substantially parallel to the rear section, and lateral sections 18 and 20 interconnecting the rear section to the arm members of the front section.

Rear section 10 transitions and smoothly merges, at one of its ends 11, into one end of lateral section 18, and at its other end 13 into one end of lateral section 20. Arm section 14 of front section 12 transitions and smoothly merges, at one of its ends 15, into a second end of lateral section 18. Arm section 16 of front section 12 transitions and merges smoothly, at one of its ends 17, into a second end of lateral section 20.

The total length of front section 12, with its arm members 14 and 16, is less than the full length of rear section 10, since opening 22 separates the arm members.

By this configuration, bracket element 2 forms dual through passages 21 and 23. Passage 21 is formed between rear section 10, lateral section 18, and front section 12. Passage 23 is formed between rear section 10, lateral section 20 and front section 12.

Bracket element 2 also comprises apertures 24 and 26 extending through rear section 10 and apertures 28 and 30 extending through front section 12. Aperture 28 extends through first arm member 14 and aperture 30 extends through second arm member 16. Apertures 24 and 28 are, at all times, in fixed parallel alignment with each other. In like manner, apertures 26 and 30 are, at all times, in fixed parallel alignment.

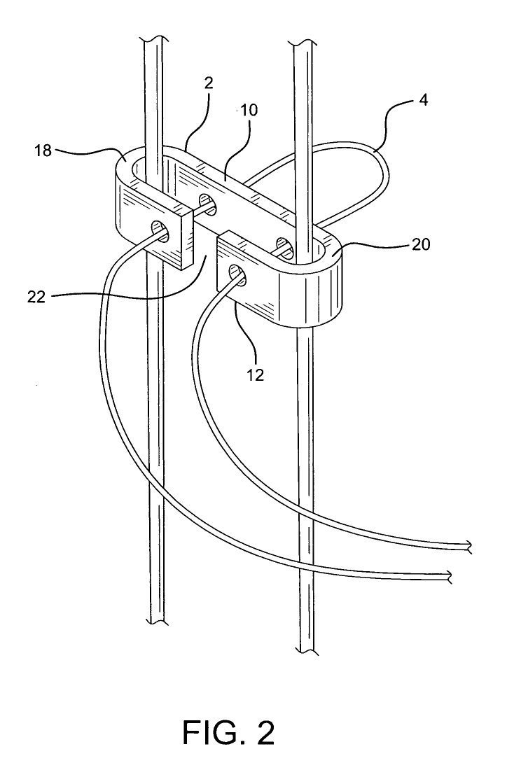

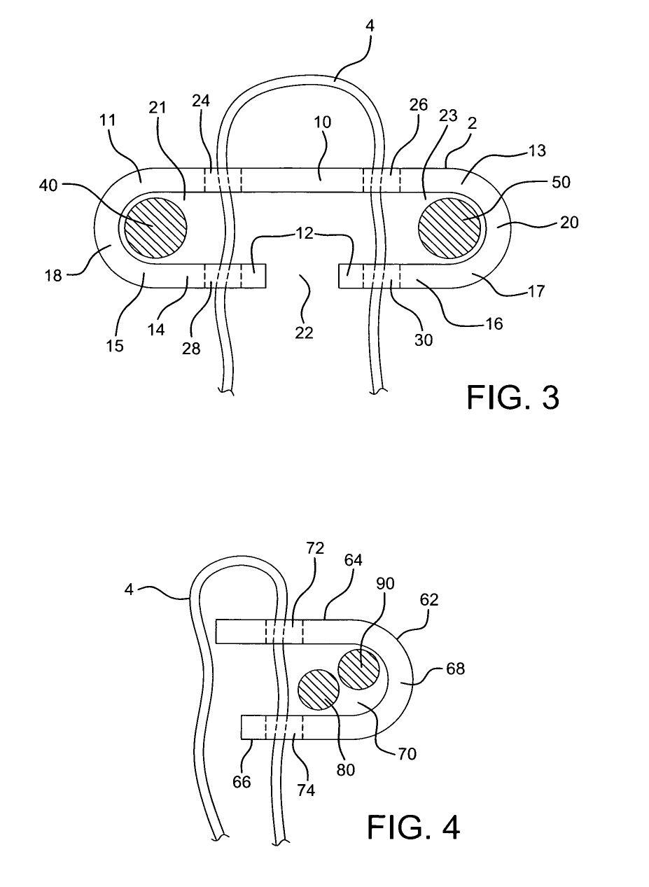

In use, ski poles 40 and 50 are inserted, one at a time, through opening 22 of bracket element 2. One ski pole 40 is positioned within passage 21 and the other pole 50 within passage 23. Locking line 4 is then threaded through apertures 28, 24, 26, and 30, as best seen in FIGS. 2 and 3, thereby totally encircling ski poles 40 and 50 within the now closed boundaries of passages 21 and 23. The boundaries of passage 21 are thus circumscribed and defined by rear section 10, lateral section 18, front section 12 and locking line 4. Similarly, the boundaries of passage 23 are circumscribed and defined by rear section 10, lateral section 20, front section 12, and locking line 4.

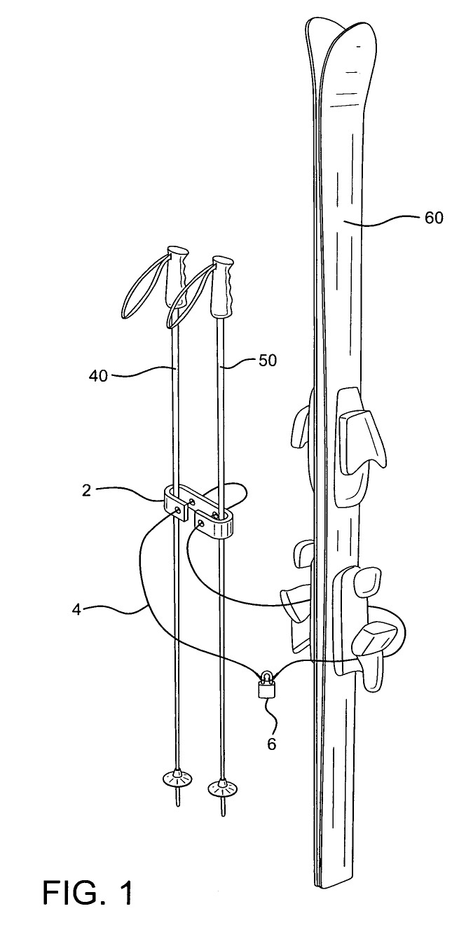

Once ski poles are positioned within passages 21 and 23, bracket element 2 is locked around the ski poles by means of locking device 6. Optionally, locking line 4 can be threaded through skis 60 as well. See FIG. 1.

FIG. 4 shows an alternate embodiment of the invention, to be used more particularly with ultra-thin lightweight ski poles, e.g. carbon-graphite poles. Bracket element 62 of this embodiment comprises rear section 64, front section 66 extending less than the full length of the rear section, interconnecting lateral section 68, and through passage 70. As described with regard to the first embodiment, the ends between rear section 64 and lateral section 68, and front section 66 and the lateral section smoothly merge together. Aperture 72 extending through rear section 64 and aperture 74 extending through front section 66, are, at all times, in fixed parallel alignment.

Bracket 62 is configured to accept two thin ski poles 80 and 90 within passage 70. Locking line 4 will then be threaded through apertures 72 and 74, once again establishing the boundaries of passage 70 which will totally encircle and maintain the two ski poles; the boundaries being circumscribed and defined by rear section 64, lateral section 68, front section 66, and locking line 4. Both ski poles 80 and 90 within passage 70 are then locked by means of locking device 6, as previously described.

Bracket 62 can be fabricated by simply severing bracket 2 at the mid-point of its rear section 10. This results in an advantageous economy of manufacture, in that bracket 2 can be formed and used for larger diameter poles; and when there is a need for bracket 62, bracket 2 is easily cut in half to produce two smaller bracket units. While bracket 62 as shown in FIG. 4 is the optimum alternate design, it is contemplated that bracket 62 can also be formed such that rear section 64 and front section 66 are the same length.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A system for locking ski poles comprising:
a bracket element having a single, unitary integral body, said bracket element comprising a rear section extending the full length of the bracket element, a front section positioned directly in front and extending partially along the length of, parallel, and in spaced relation to the rear section, and a separate lateral section extending between and interconnecting the rear and front sections, the rear section merging smoothly into one end of the separate lateral section and the other end of the separate lateral section merging smoothly into the front section, and passage means formed between the rear section, separate lateral section and front section, for encircling and maintaining ski poles, said bracket further comprising rear aperture means through the rear section for the insertion of a single locking line and front aperture means through the front section for the insertion of a said locking line, the rear aperture means and front aperture means remaining, at all times, directly facing and in fixed parallel alignment with each other;
said locking line being a flexile, cord-like locking line looped through the rear aperture means and the front aperture means, whereby the locking line, the rear section, separate lateral section and front section circumscribe and define the boundaries of the passage means; and
a locking device connected to the locking line.

2. The system for locking ski poles as in claim 1 wherein the front section is less than the full length of the bracket element.

3. The system for locking ski poles as in claim 1 wherein the separate lateral section is substantially U-shaped in configuration.

4. The system for locking ski poles as in claim 1 wherein the front section comprises first and second arm members separated by an opening therebetween.

5. The system for locking ski poles as in claim 4 further comprising a second lateral section, the separate lateral section interconnecting the rear section with the first arm member and the second lateral section interconnecting the rear section with the second arm member.

6. The system for locking ski poles as in claim 4 further comprising second rear aperture means through the rear section for the insertion of the locking line, third aperture means through the first arm member for the insertion of the locking line, and fourth aperture means through the second arm member for the insertion of the locking line, the first aperture means remaining at all times in fixed parallel alignment with the third aperture means and the second aperture means remaining at all times in fixed parallel alignment with the fourth aperture means.

7. The system for locking ski poles as in claim 5 wherein the boundaries of the passage means are circumscribed and defined by the rear section, the separate lateral section, the first arm member, and the locking line, the system further comprising second passage means for encircling and maintaining ski poles, the rear section, second lateral section, second arm member, and locking line circumscribing and defining the boundaries of the second passage means.

8. The system for locking ski poles as in claim 5 further comprising second rear aperture means through the rear section for the insertion of the locking line, third aperture means through the first arm member for the insertion of the locking line, and fourth aperture means through the second arm member for the insertion of the locking line, the first aperture means remaining at all times in fixed parallel alignment with the third aperture means and the second aperture means remaining at all times in fixed parallel alignment with the fourth aperture means.
